(19) United States
(12) Patent Application Publication
(10) Pub. No.: US 2003/0137415 A1
(43) Pub. Date: Jul. 24, 2003

(54) Homeland security emergency notification system

(76) Inventor: James D. Thomson, Sandusky, OH (US)

Correspondence Address: FAY, SHARPE, FAGAN, MINNICH & McKEE, LLP, Seventh Floor, 1100 Superior Avenue, Cleveland, OH, 44114, US

(21) Appl. No.: 10/348,852

(22) Filed: Jan. 22, 2003

Related U.S. Application Data
(60) Provisional application No. 60/350,576, filed on Jan. 22, 2002.

(51) Int. Cl. G08B 1/08

(52) U.S. Cl. 340/539.1; 340/506

(57) ABSTRACT

A safety messaging apparatus for transmitting a targeted safety-related message containing at least one of audio content and visual content from a central location to at least one selected location includes a message construction processor at the central location that constructs the targeted safety-related message for transmission responsive to an identified potential or actual safety hazard affecting the selected location. The message includes at least one of information regarding the safety hazard and a form message corresponding to the safety hazard. A message encoding processor at the central location encodes the message preparatory to transmission. The encoding includes at least associating the message with a notification device address. The encoded message is transmitted. A notification device at the selected location includes a device address and a message reconstruction processor for reconstructing a message representation based at least on the encoded message, responsive to the notification device address contained in the encoded message corresponding to the device address. A message player in communication with the notification device continually plays the message audibly or visually at the selected location.

### CROSS-REFERENCE TO RELATED APPLICATION

This application claims the benefit of U.S. provisional application Serial No. 60/350,576, filed Jan. 22, 2002.

### BACKGROUND OF THE INVENTION

The subject invention is directed toward the safety, security and, emergency services arts and, more particularly, to a notification, warning, and/or advisory system adapted to provide specific information, security, emergency, or safety instructions to targeted locations potentially or actually threatened by a safety hazard. However, the invention may also find application in other environments or situations where information is to be delivered from a centralized location to targeted areas, such as in military operations, roadways, and the like.

The invention is particularly useful when used in connection with safety or emergency services personnel such as “9-1-1” operators or dispatchers and will be described with particular reference thereto; however, the invention is capable of broader application and could be used in many other environments including anywhere security or safety monitoring is performed from a central location of homes, government, or business establishments. Such centralized safety or emergency services operators include, for example, homeland security offices, security alarm companies, home monitoring groups, ambulance or health care service providers, hazardous materials monitoring stations, and safety personnel monitoring chemical or biological laboratory operations, airport security, military base security, and the like.

Safety monitoring is frequently performed from centralized locations. The monitoring can include passive monitoring, i.e. receipt of telephonic notification of emergencies such as fires or automotive accidents, or active monitoring employing thermal, chemical, or other types of sensors. Upon identification of a hazardous or potentially dangerous situation, the centralized monitoring typically: (1) dispatches authorized and qualified personnel such as firemen to ascertain, control, and ultimately eliminate the danger; and (2) notifies people in the affected area of the potential or actual danger or hazard.

Considerable effort has been expended in the art toward developing the dispatching aspect of monitoring response, especially in the area of community safety. Most U.S. communities now have well-established systems for receiving notification of a location of danger, i.e. via a “9-1-1” telephonic emergency calling system, and efficiently dispatching police, fire, and ambulance services to the affected area. The positive effect of these dispatching systems is seen in more rapidly controlled fires with less damage to surrounding buildings, and in emergency medical cases frequently delivered to hospitals within a few minutes of calling.

However, the second aspect of centralized safety monitoring, that of notification of potentially endangered people, has lagged far behind. In community situations, such warnings are usually limited to audible fire, tornado or air raid alarms, public address (PA) systems, and television and radio emergency broadcast systems. Even in laboratories dealing with hazardous materials or biological agents and in other inherently dangerous environments, notification systems are frequently only slightly more sophisticated, employing, for example, color coded warning lights to indicate the type of hazard.

These notification methods have a number of disadvantages. Audible warning alarms or lights are only useful to the extent that the person receiving the warning (i) knows what type of hazard is associated with the warning sound or light; and (ii) knows the appropriate course of action necessary to minimize the likelihood of personal injury. Warning lights and alarms do not provide highly specific information about the hazard. For example, a tornado warning alarm does not indicate where or when the triggering tornado event was detected. Color-coded alarm lights are limited to a few colors which are easily distinguishable and meaningful to the observer, and so can only convey broad types or locations of hazards.

Warning alarms or lights also require the hearer or observer to make the mental connection between the type of sound or light and the danger. Such connection, while possibly easily performed under normal circumstances, can be much more difficult under the pressure and chaos of a hazardous situation. Furthermore, bright, flashing lights or loud repetitive safety alarms can add to the confusion and chaos and make the situation even more dangerous.

Public address systems have the advantage of providing specific information. However, the PA system is located on-site without instantaneous communication with the centralized monitoring. Hence, there is a delay between the centralized monitoring becoming appraised of the situation and the PA system broadcasting information about the hazard. Further, since most PA systems are privately owned and operated, e.g. by an office building operator, there is frequently no standardized process for transmitting the information from centralized monitoring to the PA system. This can result in a failure to provide PA information, or mis-communication of the information. Successful use of the PA system in hazardous situations also presupposes that the PA system operator actually knows the proper course of action to be followed.

More problems can arise when the alarm is activated, not from centralized monitoring, but by an affected person. Well known are the problems arising from “false” fire alarm activations, which can produce unnecessary panic and resultant inconvenience or injuries. Further, because the ubiquitous fire alarm is often the only safety warning device available, the alarm is often activated for other types of safety hazards, such as bomb threats or ventilation problems.

Emergency broadcast systems are useful only if the person who is to be warned happens to be watching television or listening to the radio carrying the broadcast. Emergency broadcast systems transmit to the entire viewing or listening area, which typically encompasses an entire metropolitan area, and cannot be targeted to particular areas. Warning sounds and lights can be somewhat better targeted, but still cannot be precisely targeted to affected individuals. Emergency broadcast systems also depend upon house electricity and can be deactivated through loss of electrical power such as often accompanies dangerous situations.

The present invention contemplates an improved method and apparatus for communicating safety information from a centralized monitoring to potentially or actually affected areas, which overcomes the aforementioned limitations and others.

### SUMMARY OF THE INVENTION

The system is comprised of an electronic circuit at a second location that is powered by battery, household current, telephone line current, or the like. The electronic circuit receives and identifies an encoded signal comprised of a tone, sequence of tones, modem, or the like. The encoded signal is transmitted through the air by radio frequency (RF), microwave, infrared, or any other types of signals, or over a telephone line, a cable television line, an electric power line, or other physical conduit from a first location (i.e., an emergency dispatch center, centralized monitoring station, or the like) for the purpose of notifying individuals at the second location of imminent danger security breaches, or emergency conditions and provide said individuals with instructions as to what course of action they should take to avoid injury or death.

In one embodiment, a device is located within a residence, office, business or other setting and is powered by a self-contained battery. The device comprises an electronic circuit including a microprocessor chip. The device is adapted to receive an encoded signal, such as an electronic modulated signal or an RF signal, from an associated emergency dispatcher at a central monitoring location. The device decodes said signal and operates a speaker or other device which emits an audible signal based on the decoded signal. The audible or visual signal suitably includes a siren, whistle, or other attention-getting noise, followed by one of a number of preprogrammed audible messages (e.g., “Seek shelter immediately”, “Stay in your homes”, “Tune to the Emergency Broadcast Network for instructions”, “Chemical and/or Biological Hazard Detected” or the like).

The preprogrammed audible message is selected based on the decoded message to instruct individuals in the residence, office, business or other setting of the appropriate course of action to be taken to prevent injury or death. The siren, whistle, or other attention getting noise is also optionally selected based on the decoded message. For example, a brief, relatively low volume noise can be used to indicate a danger which is not immediate or life-threatening, such as a chemical spill in a nearby but non-adjacent area, while a loud, penetrating siren can be used to indicate a chemical spill at the residence, office, business or other setting which poses an immediate and potentially mortal threat.

In a suitable embodiment, the device is activated by a human or automated emergency dispatcher, who selects and transmits the encoded message. The dispatcher is, for example, a local 9-1-1 dispatcher, a statewide or even national dispatcher (e.g., a dispatcher at the Office of Homeland Security) . For interoperability, the encoded signal optionally includes a signal or signals relayed by a satellite or plurality of satellites.

An emergency dispatcher interface typically includes one or more dispatch center databases, such as a Computer Aided Dispatch system, to select which devices situated in individual residences, offices, businesses, or other settings, locations, areas are to be activated. The selection is based on, for example, address or telephone number.

Each device preferably has an associated identification code. In a suitable identification, a plurality of DIP switches specify the identification code. The end user or an installer programs in the identification code using the DIP switches. A fixed code can be stored in a programmable read only memory (PROM), however. The identification code uniquely identifies the device, based for example on where the building is geographically located (i.e., its street address). In order to provide a sufficient number of addresses, it is anticipated that the identification code comprises at least ten (10) numbers, and perhaps as many as fifteen (15) or more numbers. An exemplary identification code includes: a two (2) digit state code; a three (3) digit county code; a three (3) digit area code; and a seven (7) digit telephone number.

By correlating the identifier activation number specifically to the end-user's street address, emergency dispatch centers such as a 911 center or personnel at the Office of Homeland Security not only have the capability of broadcasting emergency messages to widespread geographic areas (i.e., city-wide broadcasts), but also have the capability of delivering target- or site-specific messages to individual residences, businesses, and the like within a smaller geographic area (e.g., warning residents of a particular street or block of a street exposed to a specific hazard).

In one embodiment, the device selectively plays the message until it has been deactivated or reset by the end user, for example by using a reset/deactivate button. In another embodiment, the device automatically deactivates after a pre-determined period of time. In yet another embodiment, the device is deactivated by the emergency dispatcher via an RF or other signal. It is also contemplated to combine these mechanisms to provide multiple pathways for deactivating the device once it is activated.

Preferably, the device includes a battery level monitor and/or an audible or visual “low power level” indicator. In order to assure continual device operation, it is contemplated to employ a plurality of power source options, such as battery power, battery plus line voltage recharging, solar power plus a battery backup, line voltage power with battery backup, and the like.

Numerous advantages and benefits of the present invention will become apparent to those of ordinary skill in the art upon reading the following detailed description of the preferred embodiment.

### BRIEF DESCRIPTION OF THE DRAWINGS

The invention may take form in various components and arrangements of components, and in various steps and arrangements of steps. The drawings are only for the purpose of illustrating preferred embodiments and are not to be construed as limiting the invention.

FIG. 1 illustrates a typical configuration for the delivery of targeted safety or security instructions or other information employing an embodiment of the invention.

FIG. 2 is a schematic diagram of an apparatus for delivering targeted safety or security instructions or other information to a targeted location in response to a centralized monitoring event detection.

FIG. 3 is a flow chart of a method for delivering targeted safety or security instructions or other information to a targeted location in response to a centralized monitoring event detection.

### DETAILED DESCRIPTION OF THE PREFERRED EMBODIMENTS

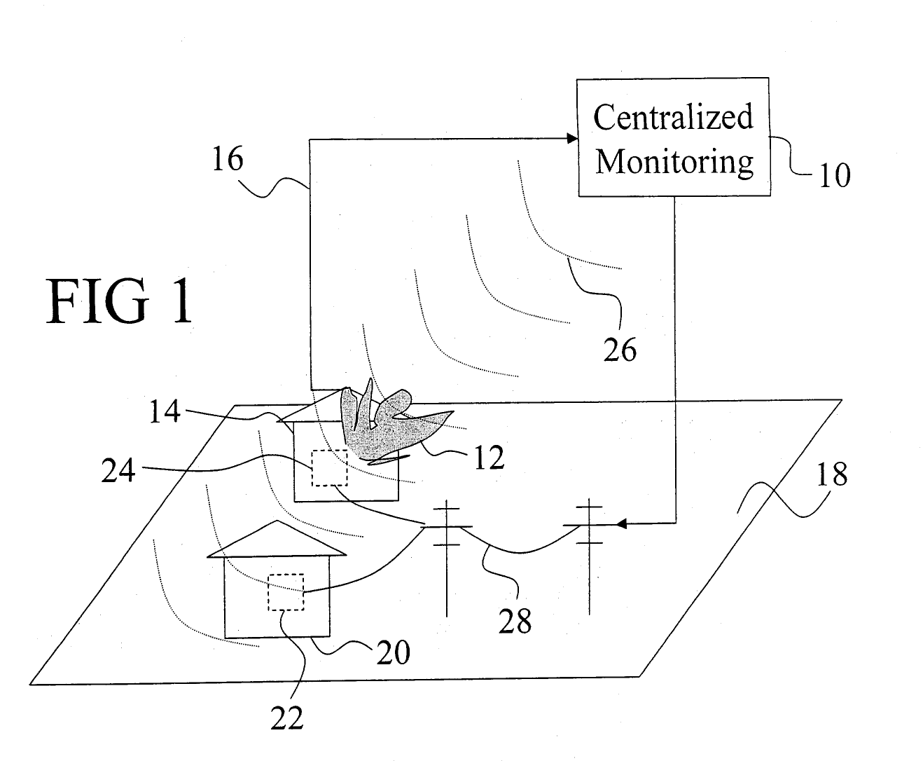

With reference to FIG. 1, a typical configuration for the delivery of targeted safety or security instructions or other information employing an embodiment of the invention is described. A centralized monitoring 10, for example an emergency dispatcher, police dispatcher, a dispatcher at the Office of Homeland Security, safety monitoring station of a hazardous materials laboratory, or the like, performs monitoring for safety-related incidents. The monitoring is optionally passive, based for example upon receiving telephonic messages of chemical spills, fires, bad weather, criminal acts such as detonation of biological or “dirty” bombs, medical emergencies, security breaches, and the like from the public, patrolling police officers, employees, Homeland Security Officers, or other individuals (not shown) not directly associated with the central monitoring. Alternatively or in combination with such passive monitoring, the centralized monitoring 10 can employ active monitoring such as automated burglar alarms, chemical, thermal, or other types of sensors in a laboratory, and the like (not shown).

A safety-related incident is detected, such as a fire or toxic chemical cloud 12 in a house 14. An indication of the event 12 is transmitted 16 to the centralized monitoring 10. The centralized monitoring 10 identifies an affected area 18 including the location 14 of the incident 12 and nearby locations such as a house 20 which are potentially or likely affected by the incident 12. The centralized monitoring 10 identifies one or more notification devices 22, 24 at the location 14 of the incident 12 or within the affected area 18. Appropriate messages are composed (not shown in FIG. 1) for transmission to the notification devices 22, 24. The messages are not generally identical for all the devices 22, 24. For the exemplary chemical cloud incident 12 of FIG. 1, a suitable message of the form:

“Warning: There is a chemical spill in a nearby building. Please go to the nearest exit and wait for further instructions. Appropriate crews have been dispatched to the location.”

is appropriately sent to the notification device 22. Optionally, the message sent to the notification device 22 includes the address of the location 14 of the incident 12. A different message of the form:

“Warning: There is a chemical spill in the building. Please stay calm, and leave the building immediately through the nearest exit.”

is appropriately sent to the notification device 24. The messages are transmitted through the air by radio frequency (RF), microwave, infrared, or other types of signals 26, or over a telephone line, a cable television line, an electric power line, or other physical conduit 28. Multiple transmission paths are also contemplated.

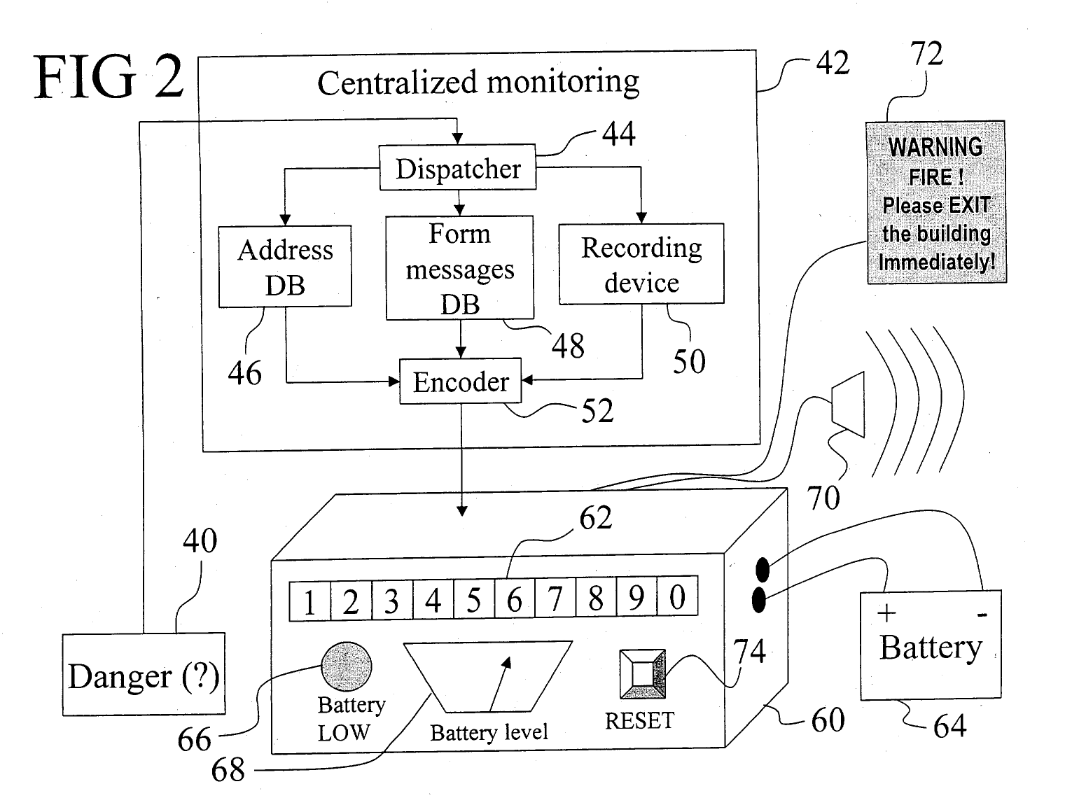

With reference to FIG. 2, a schematic diagram of an apparatus in formed accordance with the invention for delivering targeted safety instructions or other information to a targeted location in response to a centralized monitoring event detection is described. A report of a potentially or actually dangerous event or incident 40 is received at a centralized monitoring 42, for example an emergency dispatching office, a police station, the Office of Homeland Security, a safety monitoring station of a hazardous materials laboratory, or the like. In the usual case, a dispatcher 44 who is an employee or other worker at the centralized monitoring 42 is made aware of the event or incident 40 through telephonic communication or through triggering of a fire alarm or other sensor (not shown).

The dispatcher 44 determines the geographic scope of potential danger and identifies notification devices in the area through the use of an addresses database 46 or the like. In a preferred embodiment, the addresses database 46 includes a table associating each device (identified by a device identification code) with a geographical location or address. The associating is done manually or using a computerized method which, for example, identifies all notification devices within a selected distance from the event 40 using known types of software for calculating geographical distances using mapping databases. In another suitable embodiment, for known hazards such as a facility employing toxic gases, a geographical danger zone is pre-defined, and the notification devices within the danger zone are preferably pre-tabulated.

For each identified notification device, a message is constructed. The message can be a form message selected from a form messages database 48 and containing standardized instructions for a range of typical dangerous events or incidents, such as fire, burglary, chemical spill, bio-hazards, bomb threats, and the like. In one suitable embodiment, the form messages database 48 located at the centralized monitoring 42 includes the actual audio or visual message pre-recorded and stored in digital or any other form. In another embodiment the form messages database 48 stores only a message code, and the actual message is pre-recorded and stored on the notification device and is recalled with reference to the message code.

As noted previously with reference to FIG. 1, the messages are not necessarily identical for every selected notification device. In the previous example, one message was sent to the house 14 in which a fire or chemical cloud 12 was reported, while a different message containing different instructions was sent to a nearby house 20.

With reference again to FIG. 2, the dispatcher 44 selectively composes a message specifically targeted to a particular notification device using a recording device 50. It is contemplated that, due to time constraints, such individualized messaging will be restricted to particularly dangerous environments such as a burning house or highly unusual events which require specialized safety instructions such as certain bio-hazards or detonation of a “dirty” bomb.

A suitable encoder 52 advantageously encodes the message. The encoder 52 (1) encodes an address which ensures proper delivery of the message to the correct notification device; and (2) encodes the message to perform data format conversion and optionally to reduce bandwidth. In a suitable encoding, the addressing uses the identification code of the notification device, and the format conversion appropriately encodes the message for transmission over telephone lines, using selected signal modulation for open air RF transmission, or the like. The encoder 52 includes appropriate electronics (not shown) such as modulators, microprocessors, signal conditioners, and the like which are arranged to perform the message encoding using known methods.

The encoded message or messages are received by the various selected notification devices, such as the exemplary notification device 60. The device 60 includes an internally stored identification code 62, which in a suitable embodiment is entered using a plurality of DIP switches. The DIP switches 62 allow the installer of the notification device 60, or an end user, to select and enter the identification code 62. DIP switches allow the identification code 62 to be easily ascertained visually, and changed as needed, but are not susceptible to inadvertent code changes due to mechanical motion or handling of the device 60. It is to be appreciated, however, that the identification code can be stored in a programmable read only memory (PROM) which s programmed during manufacture of the notification device. This prevents users from inadvertently modifying the identification code.

In the embodiment illustrated in FIG. 2, a ten (10) digit identification code 62 is shown. In another contemplated embodiment, a fifteen (15) digit identification code is employed, of the form:

SS CCC AAA NNN-NNNN

where A, C, N, and S represent digits with SS representing a two-digit state code, CCC representing a three (3) digit county code, AAA representing a three (3) digit area code, and NNN-NNNN representing a seven (7) digit telephone number, making the above-described fifteen (15) digit identification code particularly suitable for message communication through standard telephonic communication lines.

The preferred notification device 60 receives power from a battery 64. Use of a battery is advantageous because the house electricity (e.g., 1110V, 120V, 220V or other standard ac power) can be interrupted by circumstances related to the danger 40, for example in the case of an electrical fire. Although a single power source corresponding to the battery 64 is shown, other power arrangements are also contemplated such as, for example, solar power arrangements to either power the device directly, or to provide a recharging current to the battery 64. House electricity can be used, preferably in conjunction with a battery backup. In another embodiment, the battery 64 includes automatic recharging through house electricity (not shown). Because of the serious potential negative ramifications of a power failure of the notification device 60, indicators such as a low battery indicator 66 and/or a battery level indicator 68 are advantageously incorporated into the device 60 to indicate the amount or level of power or energy available to operate the notification device 60.

The notification device 60 receives the encoded message from the centralized monitoring 42. The message is decoded and, if necessary, the message code is used to retrieve the appropriate pre-recorded message. Appropriate electronics (not shown) such as demodulators, microprocessors, and read only memories (ROM's) are arranged to perform the decoding and selective message retrieval using known methods. The message is operatively transmitted to a loudspeaker 70 (or optionally a plurality of loudspeakers arranged to provide full audio coverage of the area assigned to the notification device 60) for audio messages, a display 72 for visual messages, or another appropriate output device. An audio message is preferable since a plurality of speakers 70 can be arranged throughout the house, building, or other site to ensure that every person at the location receives the message. However, a visual message may be used or desired in high-noise environments such as factory floors, or in houses where deaf people reside. In the case of a visual message, a text display can be employed using one or more languages. Alternatively or in addition to the text, recognized symbols can also be employed to indicate a fire or other hazard. The use of symbols can be advantageous if it is anticipated that persons in the area may be unable to read the language or languages available for display on the display device 72. Of course, both audio and visual messages can be combined into a single audio/visual message.

In one suitable embodiment, the battery 64 provides electrical power for the speaker 70, visual display 72, or other output device. In this manner, the message delivery is ensured even if the house electricity is interrupted due to the safety-threatening incident.

In the embodiment of FIG. 2, the device plays the message continually until it is deactivated or reset by an end user using a reset/deactivate button 74. Optionally, the device automatically deactivates after a pre-determined period of time. Optionally, the device is deactivated by the emergency dispatcher 44 via an RF or other signal. It is also contemplated to combine these mechanisms to provide multiple pathways for deactivating the device once it is activated. In environments where malicious or inadvertent deactivation is a possibility such as during a breach in national security, it is contemplated to require that the device only be deactivated or reset by the dispatcher 44 to avoid such improper deactivation. In this case, the reset button 74 is omitted or is rendered inactive through a software, DIP switch, or PROM setting.

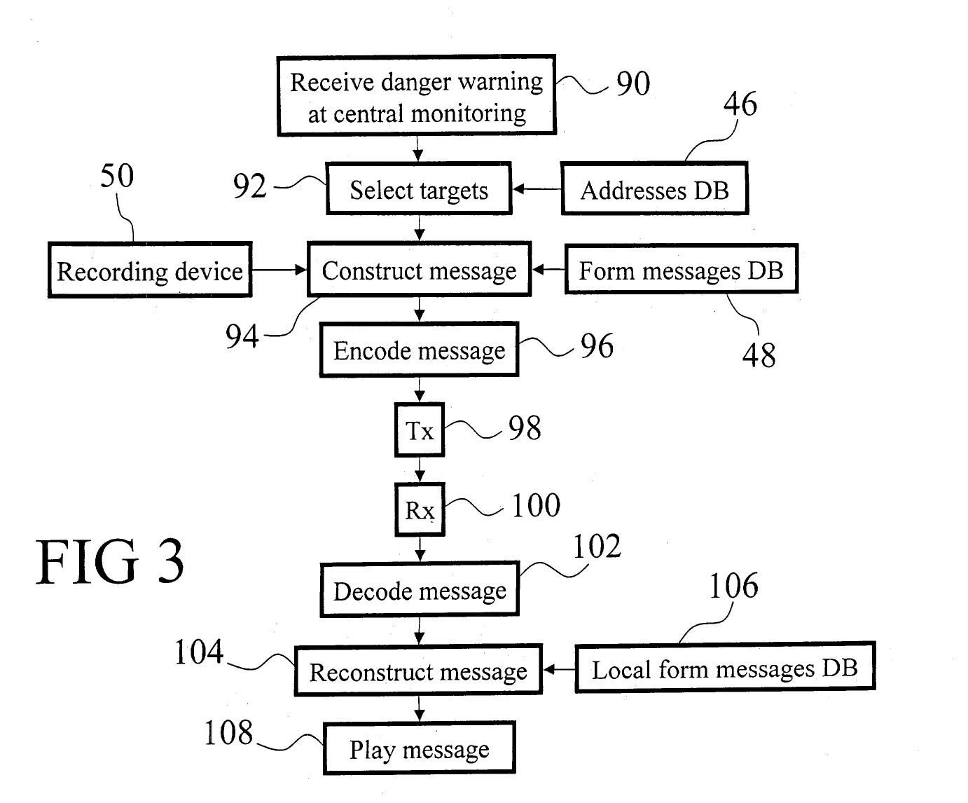

With reference to FIG. 3, a flow chart of a method for delivering targeted security or safety instructions or other information to a targeted location in response to a centralized monitoring event detection is described. A report of a potentially or actually dangerous incident is received 90 at central monitoring. Based on the type of danger and its location, notification devices are selected 92, for example using a computerized map of the locality and appropriate distance calculating software and thresholding, or using a pre-defined danger zone. The addresses database 46 is used to identify notification devices corresponding to areas which are threatened by the incident.

In a step 94, one or more messages are constructed for transmission. A single message is constructed or, as discussed previously, a plurality of messages are constructed targeting notification devices in different circumstances, e.g. a first message for the device 24 (FIG. 1) located in an area 14 in imminent danger of a fire, chemical, or biological hazard, and a second message for other devices 22 located in nearby areas 20 which are less immediately threatened by the hazard. In constructing the message, the form messages database 48 is optionally employed to reduce the time involved in constructing the message. The form messages database 48 can include actual message recordings stored in digital, analog, or any other form, or the form messages database 48 can include message codes corresponding to standardized messages. To deliver more targeted information or instructions, a recording device 50 is employed to construct a personalized audio and/or visual message.

The constructed message along with appropriate addressing information is encoded 96 for transmission 98 using known techniques. For example, if transmitting 98 is over telephone lines, message formatting and routing techniques similar to those employed for directing ordinary telephone calls are suitable. For open air transmission, appropriate message modulating with included addressing information is performed and the signal is transmitted using an RF, microwave, infrared, or other type of transmitter. The encoding 96 optionally also includes data compression or redundancy encoding using known techniques to reduce the information packet size and to minimize the possibility of errors in transmission.

The encoded 96 and transmitted 98 message is received 100 at each targeted notification device, and decoded 102 using known techniques appropriate for the selected encoding 96. If necessary, the audio or visual message is reconstructed 104 from the decoded 102 message. For example, if an address header was added for transmission, this is removed in the message reconstructing 104. If the message includes message codes inserted from the form messages database 48 during the constructing 94, the corresponding audio or visual message is reconstructed 104 by retrieving it from a local form messages database 106 located in or near the notification device. The local form messages database 106 is suitably embodied by a read only memory (ROM), optical or magnetic storage unit, or the like, arranged integrally or modularly with the notification device.

The contents of the local form messages database 106 are pre-recorded messages. For a writable local form messages database 106 such as a magnetic disk, it is contemplated that the pre-recorded contents are optionally periodically updated through message transmitting 98 and retrieving 100 during non-emergency situations.

The decoded 102 and optionally reconstructed 104 message is played 108 within the area using one or a plurality of loudspeakers, video displays or other visual display devices, or the like. The message plays continually to ensure anyone entering the area is immediately made aware of the dangerous conditions and appropriate actions to take to ensure personal safety. The message playing 108 is optionally terminated by the end user (e.g. using the reset button 74 of FIG. 1), after a pre-selected time interval (e.g., a warning continually played for 24 hours is optionally deemed sufficient so that the unit is automatically shut off after that time to prevent power drain on the battery 64), or by a reset or deactivate signal transmitted 98 by the central monitoring dispatcher and received 100 by the notification device.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the invention, it is claimed:

1. A safety messaging apparatus for transmitting a targeted safety-related message from a central location to at least one selected location, the message containing at least one of audio content and visual content, the apparatus comprising:
a message construction processor at the central location that constructs the targeted safety-related message for transmission responsive to an identified potential or actual safety hazard affecting the selected location, the message including at least one of information regarding the safety hazard and a form message corresponding to the safety hazard;
a message encoding processor at the central location for encoding the message preparatory to transmission, the encoding including at least associating the message with a notification device address;
a means for transmitting the encoded message;
a notification device at the selected location, the notification device including a device address, and a message reconstruction processor for generating a message representation based at least on a reconstruction of the encoded message responsive to the notification device address contained in the encoded message corresponding to the device address; and
a message player in communication with the notification device for continually playing the message audibly or visually at the selected location.

2. The safety messaging apparatus as set forth in claim 1, further including:
an addressing processor for selecting the at least one selected location based on a location of the identified potential or actual safety hazard.

3. The safety messaging apparatus as set forth in claim 1, further including:
an addresses database in communication with the message encoding processor, the addresses database containing information associating device addresses with geographical locations.

4. The safety messaging apparatus as set forth in claim 1, further including:
a form messages database associated with the message construction processor for providing at least one of a message code and a pre-recorded message for selective inclusion into the targeted safety-related message.

5. The safety messaging apparatus as set forth in claim 4, further including:
a local form messages database associated with the notification device for retrieving a pre-recorded message associated with a message code contained in the encoded message.

6. The safety messaging apparatus as set forth in claim 1, wherein the message player includes:
at least one speakers arranged to play the message audibly at the selected location.

7. The safety messaging apparatus as set forth in claim 1, wherein the message player includes:
at least one display device arranged to play the message visually at the selected location.

8. The safety messaging apparatus as set forth in claim 1, further including:
a battery for powering the notification device.

9. The safety messaging apparatus as set forth in claim 8, wherein the notification device further includes:
a means for monitoring power or energy available to the notification device.

10. The safety messaging apparatus as set forth in claim 8, wherein the battery additionally powers the message player.

11. The safety messaging apparatus as set forth in claim 1, wherein the notification device includes a memory storing a set of pre-recorded messages and is adapted to selectively reconstruct the decoded message and deliver the reconstructed encoded message or a one of said set of pre-recorded messages to said message player as said message representation for playing by the message player.

12. A notification apparatus for receiving a targeted safety-related message from a central location, the message containing at least one of audio content and visual content, the notification apparatus comprising:
a device address;
a message reconstruction processor for reconstructing a message representation based at least on the targeted safety-related message; and
a message player in communication with the notification device for continually playing the message audibly or visually at the selected location.

13. The notification apparatus as set forth in claim 12, further including:
an address comparator that compares the device address with an address contained in the targeted safety-related message, the address comparator in communication with the message reconstruction processor and the message player to play the targeted safety-related message conditional upon the device address corresponding with the address contained in the targeted safety-related message.

14. A method for selecting and notifying one or more locations of a potential or actual safety hazard using notification devices located at each location, the method comprising:
receiving information including at least the type and location of the hazard at a centralized monitoring;
identifying one or more notification devices located at or near the hazard;
constructing one or more safety messages containing location-specific personal safety instructions related to the hazard;
transmitting the one or more safety messages to the one or more notification devices, wherein each notification device receives personal safety instructions specific to the location of the notification device; and
playing the safety message at each location via the notification device at the location.

15. The method as set forth in claim 14, wherein the playing of the safety message includes one of:
playing an audio message; and
displaying a visual message.

16. The method as set forth in claim 14, wherein the constructing of one or more safety messages includes:
recalling a pre-recorded form message corresponding to the type of the hazard.

17. The method as set forth in claim 14, wherein the constructing of one or more safety messages includes:
recording a message containing information specifically relating to the hazard.

18. The method as set forth in claim 14, further including:
storing energy for operating a selected notification device at the location of the selected notification device.

19. The method according to claim 14, wherein the step of said information including at least the type and location of the hazard is performed by a human operator.

20. The method according to claim 19, further including delivering an alarm to said human operator.
